(19) United States
(12) Patent Application Publication
(10) Pub. No.: US 2007/0189605 A1
(43) Pub. Date: Aug. 16, 2007

(54) IMAGE FORMING DEVICE, AND DENSITY CONTROL METHOD OF THE IMAGE FORMING DEVICE

(75) Inventor: Naoki NISHIOKA, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku (JP)

(21) Appl. No.: 11/627,522

(22) Filed: Jan. 26, 2007

(30) Foreign Application Priority Data
Feb. 15, 2006 (JP) 2006-037605

(51) Int. Cl. G06K 9/34

(52) U.S. Cl. 382/176

(57) ABSTRACT

An image forming device scans an original document and generates a bi-level image signal. The image forming device obtains a first counted value by counting black pixels included in the bi-level image signal. The image forming device obtains a first generation copy by forming an image on a printing medium according to the bi-level image signal of the original document. The image forming device scans the first generation copy and generates a second bi-level image signal. The image forming device obtains a second counted value by counting the black pixels included in the second bi-level image signal. The image forming device compares whether or not the second counted value is within a target range of the first counted value, and controls the density of an image to be formed according to the comparison result.

### BACKGROUND OF THE INVENTION

1. Field of the Invention

The present invention relates to an image forming device such as a Multi Function Peripheral (MFP), which scans an original document, converts scanned data into an electric image signal, and prints an image corresponding to the electric image signal onto paper, and also relates to a method for controlling a printing density of the image forming device.

2. Description of the Related Art

Recently, an MFP including a copying function, a facsimile function, a printing function, and a scanner function or the like, and an image forming device such as a copier decompose an image of a scanned original document into pixels when copying the original document. The MFP or the image forming device converts an analog image signal into a bi-level image signal indicating density per pixel, and supplies the bi-level image signal to a printer to print an image onto paper. In such an image forming device, with a copy obtained by scanning an original document, when such an original document is copied again and again, the thickness of lines in the copies increases generating a printed image difficult to be visually confirmed.

That is, as described above, although an image is scanned per pixel and the obtained image signal is binarized, when a degree of a diagonal line placed in a range of pixels reaches a prescribed percentage or more, such pixels are determined to be black. Therefore, in a copied image, the diagonal line is wider than the diagonal line of the original document. When the copying operation is repeated several times, the thickness of the lines gradually increases, and the printed text appears to be smudged. The image quality deteriorates, and the printed image becomes extremely difficult to be confirmed by a user.

Although density may vary among printers, the density is adjusted to be within a permissible range by visually comparing a quality of an actually printed image with a target image quality. However, since the image quality is confirmed visually by this method, the adjustment varies depending on each user. When the density of the printer is set too low, black is printed pale and in a gradation of black pixels. Meanwhile, when the density of the printer is set too high, there is a gradation of white pixels. As a result, even when a thin line is expressed by a minimum width, the thin line is printed as a thick line, and the printed text in a second generation copy may result in considerably thicker lines.

According to a known process, pixels of an image signal obtained by scanning an original document are converted into white in a checkered manner per pixel to prevent an increase in the thickness of the lines in the copy. According to another known process, compressed image data is decoded, and after an image type is determined, a black image included in the decoded image data is converted into thin lines according to the determination result.

As described above, in a conventional image forming device, in order to prevent the increase in the thickness of the lines in the copies, pixels of an image signal are converted into white in a checkered manner per pixel to provide a checkered mask on the image signal or to convert the black image included in the decoded image into thin lines according to the determination result. However, when placing a checkered mask on the image signal, since this masking process covers the entire page, density of a black solid portion decreases, and lines may be disconnected in some cases.

When determining an image type and processing a black image included in the decoded image into thin lines according to the determination result, for example, a three-by-three matrix is used to convert center target pixels from black to white according to an arrangement of black pixels in the matrix. Accordingly, the black image is processed into thin lines. However, according to a setting of the matrix, the black image may be processed into extremely thin lines or may not be processed into thin lines as expected.

### SUMMARY OF THE INVENTION

In order to overcome the problems described above, preferred embodiments of the present invention provide an image forming device which can efficiently minimize an increase in the thickness of the text by carrying out a feedback control on the increase in the thickness of the text in an actual copy, and a density control method of the image forming device.

According to a first preferred embodiment of the present invention, an image forming device scans an original document and generates a bi-level image signal and counts black pixels included in the bi-level image signal. The image forming device stores a counted value, and compares a first counted value of black pixels included in the bi-level image signal generated by scanning an original image with a second counted value of black pixels included in the second bi-level image signal generated by scanning an image copied from the original image. The image forming device forms an image on a printing medium while controlling the density of the image such that the second counted value is within a prescribed range of the first counted value.

According to a second preferred embodiment of the present invention, a laser scanner unit is used for forming an image. By changing a pulse width of a laser of the laser scanner unit, the density of an image is controlled.

According to the first and the second preferred embodiments of the present invention, density of an image to be formed is controlled such that the counted value of the black pixels included in the second bi-level image signal generated by scanning a copied original document is within the prescribed range of the counted value of the black pixels of the bi-level image signal generated by scanning the original document. Therefore, a feedback control can be executed on the increase in the thickness of the text by an actual copy, and the increase in the thickness of the text can be minimized efficiently.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an example of a network system including an MFP.

FIG. 2 is a block diagram illustrating a hardware configuration of the MFP.

FIG. 3 is a block diagram illustrating a counter arranged in a printer unit to count a number of black pixels.

FIG. 4 is a block diagram illustrating a configuration of a density adjusting unit of a printer image signal processor.

FIG. 5 illustrates pulses output by the density adjusting unit.

FIG. 6 illustrates a change in the density of an image.

FIG. 7 is a flowchart illustrating a process for adjusting the density of an image.

FIG. 8 illustrates an example of a confirmation screen when changing the density.

FIG. 9 illustrates another example of a confirmation screen when changing the density.

### DETAILED DESCRIPTION OF PREFERRED EMBODIMENTS

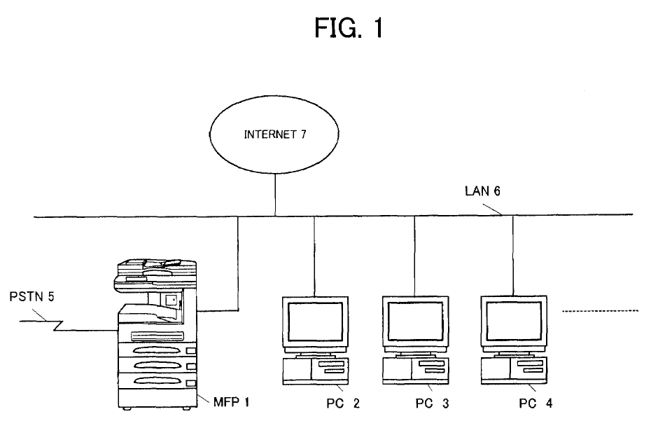

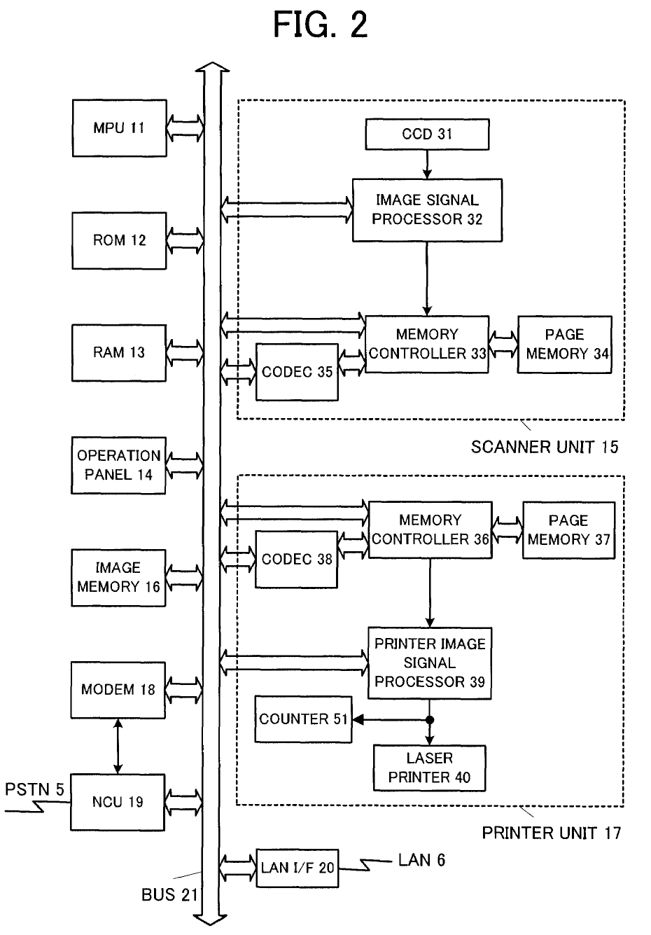

A description will be made of preferred embodiments of the present invention in which an image forming device is an MFP. FIG. 1 illustrates an example of a network system including an MFP. FIG. 2 is a block diagram illustrating a hardware configuration of the MFP.

In a network illustrated in FIG. 1, reference numeral 1 denotes an MFP; reference numerals 2, 3, and 4, etc. respectively denote a Personal Computer (PC); reference numeral 5 denotes a Public Switched Telephone Network (PSTN); reference numeral 6 denotes a Local Area Network (LAN); and reference numeral 7 is the Internet. The MFP 1 includes various functions of a copy mode, a printer mode, and a facsimile mode, and also includes an e-mail transmitting function. The MFP 1 is connected to the PSTN 5 and the LAN 6. A plurality of PCs 2, 3, and 4, etc., are connected to the LAN 6 as terminal devices. The LAN 6 is also connected to the Internet 7. The MFP 1 can transmit and receive e-mail via the Internet 7.

FIG. 2 is a block diagram schematically illustrating a configuration of a control system of the MFP 1. As illustrated in FIG. 2, the MFP 1 includes a Micro Processing Unit (MPU) 11, a Read Only Memory (ROM) 12, a Random Access Memory (RAM) 13, an operation panel 14, a scanner unit 15, an image memory 16, a printer unit 17, a modulator-demodulator (MODEM) 18, a Network Control Unit (NCU) 19, and a LAN interface (LAN I/F) 20. Each of the units 11 through 20 is connected via a bus 21.

The MPU 11 controls each of the hardware components of the MFP 1 via the bus 21, and executes programs stored in the ROM 12. The ROM 12 stores various programs and operation messages necessary for the operation of the MFP 1. The RAM 13 preferably includes a Static RAM (SRAM), a Synchronous Dynamic RAM (SDRAM) or the like, and stores temporary data that is generated when a program is executed. The operation panel 14 includes a display unit and a plurality of keys. The display unit displays an operation status of the MFP 1 and also displays a screen for operating various functions. The plurality of keys enable a user to operate the MFP 1.

The scanner unit 15 includes an Auto Document Feeder (ADF) and/or a Flat Bed Scanner (FBS) or the like. The scanner unit 15 scans an original document by a line image sensor using a Charge Coupled Device (CCD) or the like, and outputs dot image data. As illustrated in FIG. 2, the scanner unit 15 includes a CCD 31, an image signal processor 32, a memory controller 33, a page memory 34, and a coder and decoder (CODEC) 35. The image signal processor 32 binarizes an image signal output from the CCD 31. The memory controller 33 stores binarized image data for one page in the page memory 34. The memory controller 33 retrieves the binarized image data from the page memory 34, and outputs the image data to the CODEC 35. The CODEC 35 encodes the image data for one page by the Modified Huffman (MH), the Modified Relative Element Address Designate (MR), or the Modified MR (MMR) scheme, and outputs the image data to the bus 21.

The image memory 16 includes a DRAM or other suitable data storage device. The image memory 16 stores transmission image data, received image data, or image data scanned by the scanner unit 15. The printer unit 17 preferably includes a laser printer, and prints out received data or print data transmitted from the remote PCs 2, 3, and 4 or the like.

As illustrated in FIG. 2, the printer unit 17 includes a memory controller 36, a page memory 37, a CODEC 38, a printer image signal processor 39, a laser printer 40 including a laser scanner unit as a scanning mechanism, and a counter 51 for counting a number of black pixels. When printing, the CODEC 38 decodes coded image data from the image memory 16, and the memory controller 36 stores the decoded image data of one page in the page memory 37. The memory controller 36 retrieves the image data of one page from the page memory 37, and supplies the image data to the printer image signal processor 39. The printer image signal processor 39 outputs a control signal to the laser printer 40. The counter 51 will be described later.

The MODEM 18 is connected to the bus 21. The MODEM 18 includes functions such as a faxmodem capable of carrying out facsimile communication. The MODEM 18 is connected to the NCU 19, which is also connected to the bus 21. The NCU 19 is hardware which carries out an operation for connecting and releasing an analog communication line. According to necessity, the NCU 19 connects the MODEM 18 to the PSTN 5. The LAN interface 20 is connected to the LAN 6. The LAN interface 20 receives a signal from the Internet 7, and also transmits a signal and data to the LAN 6. The LAN interface 20 executes interface processing such as signal conversion and protocol conversion.

The MFP 1 is configured as described above. During facsimile transmission, image data of an original document is scanned by the scanner unit 15, compressed by the CODEC 35, and stored in the image memory 16. The compressed image data is retrieved from the image memory 16, modulated by the MODEM 18, and transmitted from the NCU 19 to a communication destination via the PSTN 5. Upon facsimile reception, received image data is demodulated by the MODEM 18, and stored in the image memory 16. Then, the image data is decoded by the CODEC 38, and printed out by the laser printer 40.

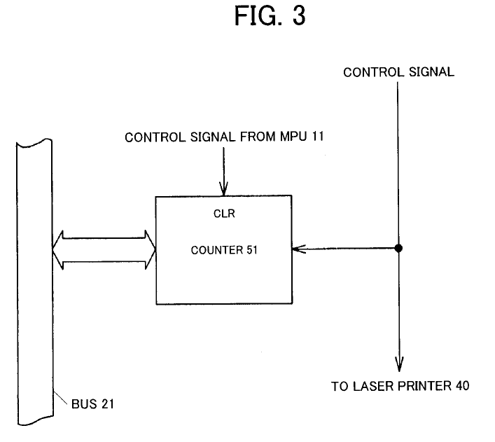

Next, with reference to FIG. 3, the counter 51 will be described. The counter 51 illustrated in FIG. 3 is provided for determining an amount of toner used by the printer, for example. An image signal output from the printer image signal processor 39 is input to the counter 51, and the counter 51 counts black pixels included in a black and white image signal (in an example illustrated in FIG. 3, logically “1”). The counter 51 is connected to the bus 21, and the MPU 11 can directly access the counted value. The counter 51 is reset by a control signal from the MPU 11. Before starting a printing operation, the MPU 11 resets the counter 51, and sets a count value to “0”.

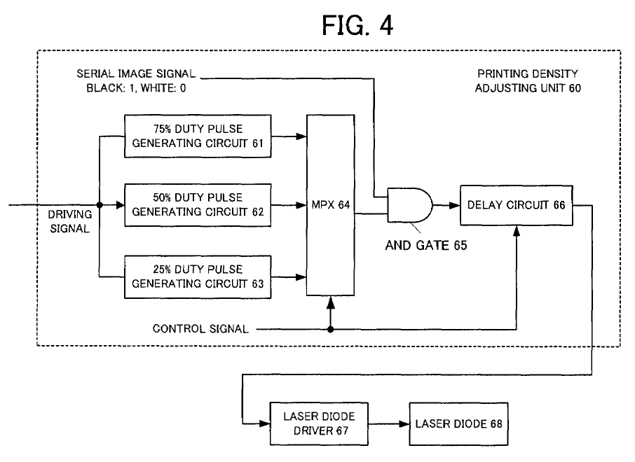

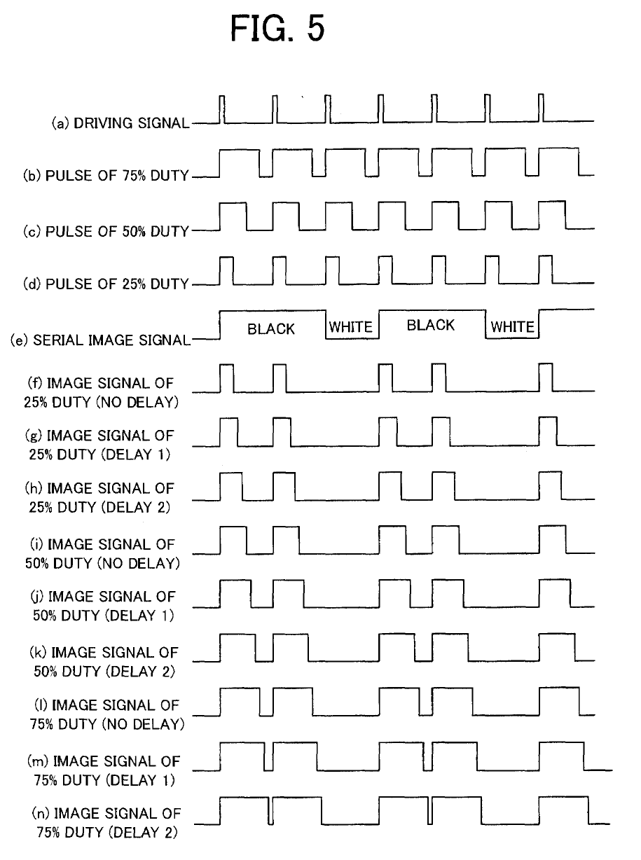

A printing density adjusting unit 60 is provided inside the printer image signal processor 39. As illustrated in FIG. 4, the printing density adjusting unit 60 includes a 75% duty pulse generating circuit 61, a 50% duty pulse generating circuit 62, a 25% duty pulse generating circuit 63, a multiplexer (MPX) 64, an AND gate 65, and a delay circuit 66. In synchronism with a driving signal (a) illustrated in FIG. 5, the 75% duty pulse generating circuit 61, the 50% duty pulse generating circuit 62, and the 25% duty pulse generating circuit 63 respectively generate pulses having a duty ratio of 75%, 50%, and 25% as illustrated respectively in (b) through (d) of FIG. 5, and supply the pulses to the MPX 64. The MPX 64 selects one of the pulses having the duty ratio of 75%, 50%, or 25% according the control signal, and supplies the selected pulse to the AND gate 65.

A serial image signal (e) illustrated in FIG. 5 and the output from the MPX 64 are input to the AND gate 65. Therefore, as illustrated by (f), (i), and (l) in FIG. 5, only when the serial image signal is black, one of the pulses having the duty ratio of 25%, 50%, or 75% is output. The delay circuit 66 delays only a trailing edge of the input pulse based on the control signal, and combines a plurality of delay elements and a logic circuit.

For example, when a control signal without delay is input, one of the pulses having the duty of 25%, 50%, or 75% illustrated by (f), (i), and (l) in FIG. 5 is directly output. When a control signal with delay 1 is input, one of the pulses having the duty of 25%, 50%, or 75% illustrated by (g), (j), and (m) in FIG. 5, in which a trailing edge is delayed, is output. When a control signal with delay 2 is input, one of pulses having the duty of 25%, 50%, or 75% illustrated by (h), (k), and (n) in FIG. 5, in which a trailing edge is further delayed, is output. Then, the output signal is input to the laser diode 68 via the laser diode driver 67 of the laser printer 40.

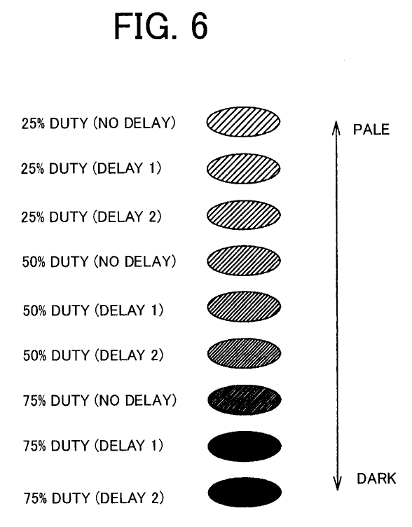

Therefore, by switching the control signal to the MPX 64 and the delay circuit 66, and by combining the duty and the delay, as illustrated in FIG. 6, it is possible to change a pulse width of the pulses generated according to the black pixels, e.g., without delay for 25% duty, delay 1 for 25% duty, delay 2 for 25% duty, without delay for 50% duty, etc., up to delay 2 for 75% duty and so forth. The density of an image can be sequentially darkened in nine levels.

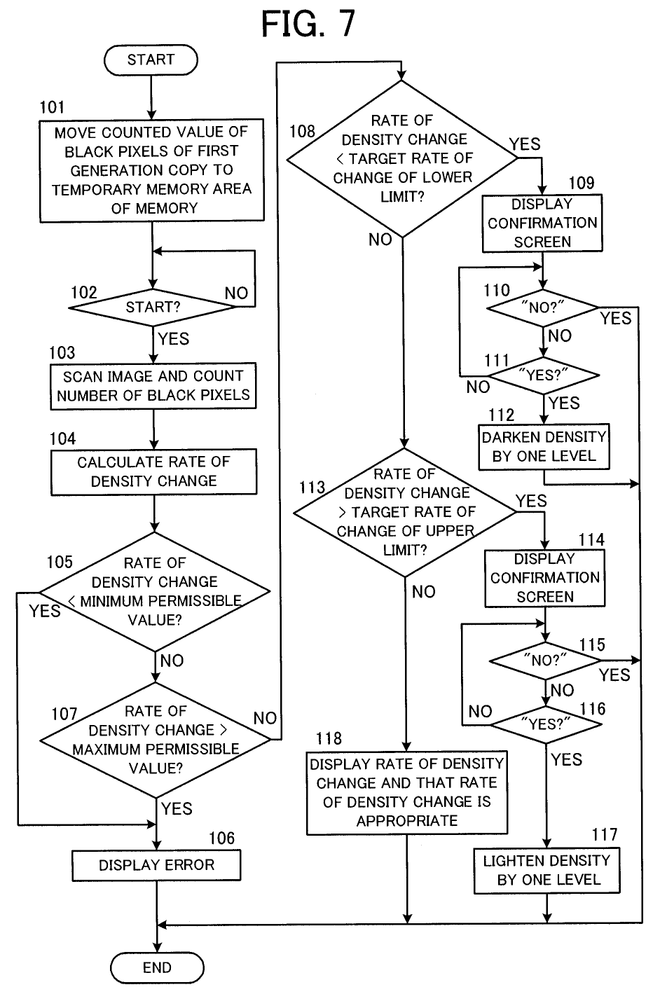

Next, with reference to the flowchart illustrated in FIG. 7, a description will be made of processes carried out when adjusting density of an image at shipment from a factory or when adjusting density of an image by a serviceperson in the field. Further, when adjusting the density of an image, an operator places a test chart on an FBS to make a first generation copy by a text mode, and a counted value of black pixels of an image signal is stored in the RAM 13.

When an operator selects “maintenance” in the display screen of the operation panel 14 and selects to adjust the density, the MPU 11 starts an image density adjusting program illustrated in the flowchart of FIG. 7. First, the counted value of the black pixels of the first generation copy is moved to a temporary memory area of the RAM 13 (step 101). Then, the MPU 11 determines whether or not the operator has pressed a start button on the operation panel 14 (step 102).

After the operator places the first generation copy on the FBS and sets the MFP 1 under a text mode, the operator presses the start button on the operation panel 14. The MPU 11 executes a scanning operation of an image by the scanner unit 15 to scan an image of the first generation copy. By inputting the scanned image data to the counter 51, the MPU 11 acquires a counted value of black pixels of an image of a second generation copy, and stores the acquired counted value in the temporary memory area of the RAM 13 (step 103).

Next, the MPU 11 calculates a rate of density change (%) by the following formula (step 104): rate of density change=(a number of pixels of the second generation copy−a number of pixels of the first generation copy)/a number of pixels of the first generation copy. Then, the MPU 11 determines whether or not the rate of the density change is smaller than the minimum permissible value, for example, 0% (step 105). When the MPU 11 determines that the rate of the density change is smaller than the minimum permissible value, the MPU 11 determines that the test chart has been copied again or that a different document has been copied. The display screen of the operation panel 14 displays an error message, e.g. “Wrong original document” (step 106), and the program ends.

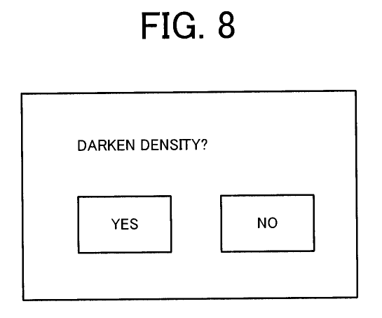

When the MPU 11 determines at step 105 that the rate of the density change is larger than or equal to the minimum permissible value, the MPU 11 determines whether or not the rate of the density change is larger than the maximum permissible value, for example, 60% (step 107). When the MPU 11 determines that the rate of the density change is larger than the maximum permissible value, the MPU 11 determines that a completely different original document has been copied, and the display screen of the operation panel 14 displays an error message (step 106). Meanwhile, when the MPU 11 determines at step 107 that the rate of the density change is smaller than or equal to the maximum permissible value, the MPU 11 determines whether or not the rate of the density change is smaller than a target rate of change of a lower limit, for example, about 7% (step 108). When the MPU 11 determines that the rate of the density change is smaller than the target rate of change of the lower limit, the MPU 11 displays a confirmation screen for changing the density as illustrated in FIG. 8 on the display screen of the operation panel 14 (step 109).

Next, the MPU 11 determines whether or not the operator has pressed “NO” in the confirmation screen of FIG. 8 (step 110). When the MPU 11 determines that the operator has pressed “NO”, the program ends. When the MPU 11 determines that the operator has not pressed “NO”, the MPU 11 determines whether or not the operator has pressed “YES” (step 111). When the MPU 11 determines at step 111 that the operator has not pressed “YES”, the MPU 11 returns to step 110 again and determines whether or not the operator has pressed “NO”. When the MPU 11 determines that the operator has pressed “YES”, the MPU 11 changes a control signal to the MPX 64 and the delay circuit 66 of the printing density adjusting unit 60 so that the density darkens by one level from the current density.

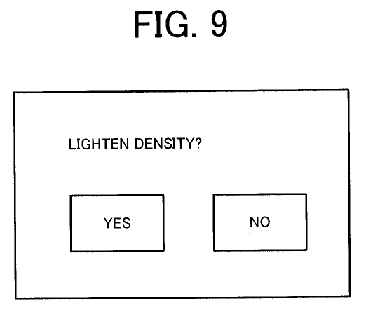

Meanwhile, when the MPU 11 determines at step 108 that the rate of the density change is larger than or equal to a target rate of change of the lower limit, the MPU 11 determines whether or not the rate of the density change is larger than the target rate of change of the upper limit, for example, about 15% (step 113). When the MPU 11 determines that the rate of the density change is larger than the target rate of change of the upper limit, the MPU 11 displays the confirmation screen for changing the density as illustrated in FIG. 9 on the display screen of the operation panel 14 (step 114).

Next, the MPU 11 determines whether or not the operator has pressed “NO” in the confirmation screen of FIG. 9 (step 115). When the MPU 11 determines that the operator has pressed “NO”, the MPU 11 ends the program. When the MPU 11 determines that the operator has not pressed “NO”, the MPU 11 determines whether or not the operator has pressed “YES” (step 116). When the MPU 11 determines at step 116 that the operator has not pressed “YES”, the MPU 11 returns to step 115 again and determines whether or not the operator has pressed “NO”. When the MPU 11 determines that the operator has pressed “YES”, the MPU 11 changes a control signal to the MPX 64 and the delay circuit 66 of the printing density adjusting unit 60 such that the density is lightened by one level from the current density (step 117).

When the MPU 11 determines at step 113 that the rate of the density change is smaller than or equal to the target rate of change of the upper limit, the MPU 11 displays the rate of the density change on the display screen of the operation panel 14, and displays that the rate of the density change is appropriate (step 118). Then, the MPU 11 ends the program.

As described above, by counting the number of black pixels, the MFP 1 detects an increase in the number of black pixels (increase in the thickness of a line) among generations of copies. When an amount of the increase in the number of black pixels is large, the MFP 1 lowers the density for forming an image to offset the increase in the number of black pixels. As described above, since the MFP 1 can carry out a feedback control on the increase in the thickness of the text by an actual copy, the MFP 1 can efficiently minimize the increase in the thickness of the text. The increase in the thickness of the text is caused by an amount of toner being larger for one pixel. When the thickness of the text increases, the amount of toner for one pixel may be reduced. This can be achieved by adjusting the pulse width of the laser printer, i.e., the density of the printer. Therefore, by feeding back the rate of increase in the number of black pixels among the generations of the copies to the printer density, the density of the printer can be adjusted efficiently.

Further, according to the above-described preferred embodiment, the MFP 1 uses a laser printer as the printer. As another example, the printer may by a Light Emitting Diode (LED) printer. When using the LED printer, the printing density can be controlled by adjusting the time of a strobe signal of an LED printer head and/or adjusting the voltage for driving the LED printer head.

The minimum permissible value, the maximum permissible value, the target rate of change of the lower limit, and the target rate of change of the upper limit described in the above preferred embodiment are just examples. Any value may be used according to the particular device. Moreover, the levels in which the density of the image is changed are not limited to nine levels. The levels of the density of an image may be changed at a lower or higher number of levels. In the above-described preferred embodiment, the image forming device is described as a digital MFP. However, the present invention is also applicable to a general copier not having a facsimile function, or any other suitable device.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming device comprising:
an image scanning unit arranged to scan an original image of an original document and generate a bi-level image signal;
an image forming unit arranged to form an image on a printing medium according to the bi-level image signal;
a counter arranged to count a value of black pixels included in the bi-level image signal;
a memory unit arranged to store the value counted by the counter;
a comparator arranged to compare a first counted value of black pixels included in the bi-level image signal generated by scanning the original image with a second counted value of black pixels included in a second bi-level image signal generated by scanning an image copied from the original image; and
a control unit arranged to control a density of an image to be formed such that the second counted value is within a target range of the first counted value.

2. The image forming device according to claim 1, further comprising:
a laser scanner unit arranged in the image forming unit; and
a density adjustment unit arranged to change a pulse width of a laser in the laser scanner unit.

3. The image forming device according to claim 2, further comprising:
a plurality of pulse generators arranged to generate pulses having different pulse widths; and
a selector arranged to select one of the pulse generators.

4. The image forming device according to claim 3, further comprising an AND gate to which the pulses output from the selector and the bi-level image signal are input.

5. The image forming device according to claim 4, further comprising a delay circuit arranged to delay a trailing edge of the pulses output from the AND gate.

6. The image forming device according to claim 1, further comprising:
a second comparator arranged to set a permissible range to be wider than the target range, and to compare whether or not the second counted value is within the permissible range of the first counted value; and
a display unit arranged to display a message when the second comparator determines that the second counted value is outside the permissible range.

7. An image forming device comprising:
means for scanning an original image of an original document and generating a bi-level image signal;
means for forming an image on a printing medium according to the bi-level image signal;
means for counting black pixels included in the bi-level image signal;
means for storing a counted value;
means for comparing a first counted value of black pixels included in a bi-level image signal generated by scanning the original image with a second counted value of black pixels included in a second bi-level image signal generated by scanning an image copied from the original image; and
means for controlling a density of an image to be formed such that the second counted value is within a target range of the first counted value.

8. The image forming device according to claim 7, further comprising:
means for scanning by laser light arranged in the means for forming; and
means for changing a pulse width for driving a laser light source in the means for scanning.

9. The image forming device according to claim 8, further comprising:
means for generating a plurality of pulses having different pulse widths; and
means for selecting one pulse from the plurality of pulses.

10. The image forming device according to claim 9, further comprising means for obtaining a logical AND of the selected pulse and the bi-level image signal and outputting a second pulse.

11. The image forming device according to claim 10, further comprising means for delaying a trailing edge of the second pulse, which is the logical AND of the selected pulse and the bi-level image signal.

12. The image forming device according to claim 7, further comprising:
means for setting a permissible range to be larger than the target range and comparing whether or not the second counted value is within the permissible range of the first counted value; and
means for providing notification when the second counted value is determined to be outside the permissible range.

13. A density control method of an image forming device, the method comprising the steps of:
scanning an original document and generating a bi-level image signal;
obtaining a first counted value by counting black pixels included in the bi-level image signal;
obtaining a first generation copy by forming an image on a printing medium according to the bi-level image signal of the original document;
scanning the first generation copy and generating a second bi-level image signal;
obtaining a second counted value by counting black pixels included in the second bi-level image signal;
comparing whether or not the second counted value is within a target range of the first counted value; and
controlling a density of an image to be formed according to a comparison result obtained in the comparing step.

14. The density control method of the image forming device according to claim 13, the method further comprising the steps of:
reducing the density of the image by one level when the second counted value is larger than the target range; and
increasing the density of the image by one level when the second counted value is smaller than the target range.

15. The density control method of the image forming device according to claim 13, the method further comprising the steps of:
setting a permissible range larger than the target range; and
providing notification of an error when the second counted value is outside of the permissible range.

16. The density control method of the image forming device according to claim 13, the method further comprising the steps of:
generating a plurality of pulses having a plurality of duty ratios;
selecting one pulse from the plurality of the pulses; and
generating a second pulse by obtaining a logic AND of the selected pulse and the bi-level image signal.

17. The density control method of the image forming device according to claim 16, the method further comprising the step of delaying a trailing edge of the second pulse.

18. The density control method of the image forming device according to claim 17, the method further comprising the steps of:
driving a laser light source by the second pulse or the second pulse of which the trailing edge has been delayed; and
forming an image by scanning by laser light from the laser light source.
